(19) United States
(12) Patent Application Publication
(10) Pub. No.: US 2009/0075730 A1
(43) Pub. Date: Mar. 19, 2009

(54) Network game system, method for processing the same, network game processing program product, and storage medium for storing program product

(75) Inventors: Masanori Ohe, Tokyo (JP); Masamitsu Hoshino, Tokyo (JP); Tomosuke Tsuda, Tokyo (JP); Kunihiko Imai, Tokyo (JP); Yousuke Tsukamoto, Tokyo (JP); Eijirou Asakura, Tokyo (JP)

Correspondence Address: WENDEROTH, LIND & PONACK, L.L.P., 2033 K STREET N. W., SUITE 800, WASHINGTON, DC, 20006-1021, US

(73) Assignee: SEGA CORPORATION

(21) Appl. No.: 12/230,756

(22) Filed: Sep. 4, 2008

(30) Foreign Application Priority Data
Sep. 11, 2007 (JP) 2007-235418

(51) Int. Cl. G06F 17/00

(52) U.S. Cl. 463/29

(57) ABSTRACT

Network game system comprising: a center server is provided with means for storing object data received from each arcade system in a database, means for executing a competing game using data on the basis of each object data, and means for distributing the arcade ID, and player ID corresponding to the object data which won the race to each arcade server; the arcade server is provided with means for comparing the arcade ID received from the center server with a player's own arcade ID, and when they match each other, for transmitting the player ID to a game device within the arcade system; the game device is provided by comparing the player ID received from the arcade server with the player ID of an storage medium, and when they match each other, for judging that the player is the winner, and for writing bonus data into the storage medium.

### TECHNICAL FIELD

The present invention relates to a network game system in which a large number of players can simultaneously participate in a computer game and, in particular, to a network game system which can execute a network game tournament on the basis of a competition using object data for each player which are generated by a game device in each arcade installed in all areas of the country.

### BACKGROUND ART

Various types of network game systems which allow a large number of players to participate simultaneously in a computer game have been proposed to date.

In a first example, user terminals (game devices) and commercial game devices are connected through a communications network, a game is developed by a commercial game device on the basis of character-specific data transferred from each user terminal, and the development of the game is achieved by the commercial game device (See, for example, Patent Document 1).

In a second example, a player's horse raised by the player in a horse racing game of an arcade game machine is allowed to participate in a race on a horse racing game site run by a web server by using a password (See, for example, Patent Document 2).

In a third example, in addition to a game server which is connected to a user terminal through a communications network, a second server (for example, a betting server) is provided which executes a second game (a betting game) using the data of a first game (for example, a competing game) executed by the game server, thereby allowing a third party to participate in the second game (the betting game) (See, for example, Patent Document 3).

In a fourth example, a plurality of game devices divided into groups are connected to a totalizing computer through a communications network, the game results of the game devices are collected by the totalizing computer in order to execute group-by-group totalization such as arcade-by-arcade totalization and area-by-area totalization (See, for example, Patent Document 4).

[Patent Document 1] Japanese Patent Application Laid-Open Publication No. 8-829

[Patent Document 2] Japanese Patent Application Laid-Open Publication No. 2002-35429

[Patent Document 3] Japanese Patent Application Laid-Open Publication No. 2002-85852

[Patent Document 4] Japanese Patent Application Laid-Open Publication No. 2006-334433

### SUMMARY OF INVENTION

### Problems to be Solved by the Invention

In conventional game systems, no network games have been achieved which produce a sense of togetherness at a arcade at which players play games and in an area in which the arcade is located, with said network games including those such as a competing game using a representative object of each arcade as a representative of the arcade and a competing game using an object representing each area as a representative of the area. In addition, if a player is victorious (ranks in first place) in a conventional network game, only the winner benefits, and only the winner feels a strong emotion and gains a feeling of satisfaction, meaning that the outcome of a competing game in the network game being played by the player is not experienced by other players.

In a conventional network game, therefore, players who have been defeated or players who did not originally participate in the network game, even if a winner occurs in the arcade they are playing at, are not interested in the winner and cannot enjoy themselves, because the win has no connection with their own game result and the data of player objects corresponding to the players.

The present invention has been developed in view of the above-described problems. It is an object of the present inventions to provide a network game system, its associated processing method, a network game processing program, and a storage medium storing the program that allows the execution of a competing game using various types of nationwide networks, such as a competing game using a network that provides a representative object of each arcade and a competing game using a network that provides a representative object of each area and, when compared to conventional network games, allows other players to participate in the outcome and even allows players who have been defeated and players who have not participated in the competing game to be given a bonus.

### Means for Solving the Problems

The present invention relates to a network game system, its associated processing method, a network game processing program, and a storage medium. With respect to the network game system, the above-described object of the present invention is achieved by a network game system used for executing a competing game using a network, comprising: a arcade system in which a game device provided with a card processing section which reads at least one player ID from an external storage medium possessed by a player or writes data into the storage medium and a arcade server are connected to each other in a mutually communicable manner; and a center server which is connected to the arcade system installed in each of a plurality of arcades through a communications network in a communicable manner, wherein the center server comprises: means for regarding object data satisfying a predetermined condition out of object data of each player generated by a game executed by the game device as a competing object, receiving the object data of the competing object and the player ID corresponding to the data from the arcade system of each arcade, and storing them in a database in connection with a arcade ID specifying a transmission source arcade and an area ID specifying an area to which the arcade belongs;

means for executing a competing game using each object data corresponding to the arcade ID extracted from the database as a first game for each arcade ID in order to determine a representative object of each arcade, for executing a competing game using the representative object data of each arcade as a second game for each area ID in order to determine the representative object data of each area, and for executing a nationwide championship game using the representative object data of each area as a third game in order to determine the representative object data of the area which ranked first in the third game to be champion object data; and means for regarding the arcade ID and the area ID corresponding to the object data which won the third game and the object ID and the player ID of the object data as distribution data and distributing it to the arcade server of each arcade, wherein the arcade server comprises means for comparing the area ID within the distribution data received from the center server with the area ID to which a player's own arcade belongs, and when they match each other, for transmitting a first notification message including the player ID within the distribution data to the game device, wherein the game device which has received the first notification message comprises means for writing first bonus data into the external storage medium.

The above-described object of the present invention is achieved more effectively by allowing the arcade server to compare the arcade ID within the distribution data received from the center server with a player's own arcade ID, and when they match each other, to transmit a second notification message indicating the fact to the game device, and allowing the game device which has received the second notification message to execute specific image processing in accordance with the second notification message, by providing the arcade server with the means for comparing the arcade ID within the distribution data received from the center server with a player's own arcade ID, and when they match each other, for transmitting the player ID within the distribution data to the game device, and allowing the game device to compare the player ID within the distribution data received from the arcade server with the player ID read from a storage section of the external storage medium possessed by the player, and when they match each other, to judge that the player specified by the player ID is the player corresponding to the champion object data, and to write first bonus data into the external storage medium, by having the game device comprise a plurality of satellite devices and a main monitor, and when it receives the first notification message or the second notification message, to allow a display section of the satellite device or the main monitor to display a specific image in accordance with either one of the notification messages, and by allowing the arcade system to further comprise a terminal device which is connected to the center server in a communicable manner, wherein the center server further comprises means for receiving the expectation voting data of voting participants who predicted the result of the competing game from the terminal device before the execution of the competing game, and executing a expectation game on the basis of the expectation voting data of each voting participant, respectively.

With respect to the network game system processing method, the above-described object of the present invention is achieved by a competing game processing method in a network game system comprising: a arcade system in which a game device provided with a card processing section which reads at least one player ID from an external storage medium possessed by a player or writes data into the storage medium and a arcade server are connected to each other in a mutually communicable manner; and a center server which is connected to the arcade system installed in each of a plurality of arcades through a communications network in a communicable manner, wherein the center server comprises: a step for regarding object data satisfying a predetermined condition out of object data of each player generated by a game executed by the game device as a competing object, receiving the object data of the competing object and the player ID corresponding to the data from the arcade system of each arcade, and storing them in a database in connection with a arcade ID specifying a transmission source arcade and an area ID specifying an area to which the arcade belongs; a step for executing a competing game using each object data corresponding to the arcade ID extracted from the database as a first game for each arcade ID in order to determine a representative object of each arcade, for executing a competing game using the representative object data of each arcade as a second game for each area ID in order to determine the representative object data of each area, and for executing a nationwide championship game using the representative object data of each area as a third game in order to determine the representative object data of the area which ranked first in the third game to be the champion object data; and

a step for regarding the arcade ID and the area ID corresponding to the object data which won the third game and the object ID and the player ID of the object data as distribution data and distributing it to the arcade server of each arcade, wherein the arcade server comprises means for comparing the area ID within the distribution data received from the center server with the area ID to which a player's own arcade belongs, and when they match each other, for transmitting a first notification message including the player ID within the distribution data to the game device, wherein the game device which has received the first notification message comprises means for writing first bonus data into the external storage medium.

With respect to the network game processing program, the above-described object of the present invention is achieved by a program for creating a network game system comprising: a arcade system in which a game device provided with a card processing section which reads at least a player ID from an external storage medium possessed by a player or writes data into the storage medium and a arcade server are connected to each other in a mutually communicable manner; and a center server which is connected to the arcade system installed in each of a plurality of arcades through a communications network in a communicable manner to execute a competing game, wherein the center server executes: a step for regarding object data satisfying a predetermined condition out of object data of each player generated by a game executed by the game device as a competing object, receiving the object data of the competing object and the player ID corresponding to the data from the arcade system of each arcade, and storing them in a database in connection with a arcade ID specifying a transmission source arcade and an area ID specifying an area to which the arcade belongs; a step for executing a competing game using each object data corresponding to the arcade ID extracted from the database as a first game for each arcade ID in order to determine a representative object of each arcade, for executing a competing game using the representative object data of each arcade as a second game for each area ID in order to determine the representative object data of each area, and for executing a nationwide championship game using the representative object data of each area as a third game in order to determine the representative object data of the area which ranked first in the third game to be the champion object data; and a step for regarding the arcade ID and the area ID corresponding to the object data which won the third game and the object ID and the player ID of the object data as distribution data and distributing it to the arcade server of each arcade, wherein the arcade server executes a step for comparing the area ID within the distribution data received from the center server with the area ID to which a player's own arcade belongs, and when they match each other, for transmitting a first notification message including the player ID within the distribution data to the game device, wherein the game device which has received the first notification message executes a step for writing first bonus data into the external storage medium.

For the storage medium, the above-described object of the present invention is achieved by a configuration that stores the network game processing program.

### Effects of the Invention

According to the present invention, various types of nationwide network games such as a competing game which use a network using a representative object of each arcade and a competing game which uses a network using a representative object of each area can be executed.

This allows other players to share profits in each arcade to which each representative object corresponding to each player belongs and in each area to which each arcade belongs by the result of a competing game by a representative object and a representative object of each area, allows each player possessing each representative object to have a sense of arcade/area representation, and allows other players to expect a good result in the competing game played by the player possessing the representative object, producing “a sense of togetherness in the area.”

In addition, players who have been defeated or players who did not originally participate in the network game can predict the outcome of the competing game played by area representatives and gain profits through the result. This allows all the players including players who have been defeated or players who did not originally participate in the game to enjoy a competing game to the end using a nationwide network. The present invention can further satisfy the desire of the winner to flaunt his or her achievements.

### BRIEF DESCRIPTION OF DRAWINGS

FIG. 1 is a block diagram showing an example of the overall configuration of a network game system in accordance with the present invention.

FIG. 2 is a schematic view showing a configuration example of a game system in a arcade in accordance with the present invention.

FIG. 3 is a block diagram showing an example of the internal structure of a terminal device in accordance with the present invention.

FIG. 4 is a schematic view showing schedule data for use in the progress control of a network game in accordance with the present invention.

FIG. 5 is a schematic diagram for illustrating the progress of a network game in accordance with the present invention.

FIG. 6 is a picture showing an example of an image displayed in the nationwide championship game in accordance with the present invention.

FIG. 7 is a flowchart for illustrating main game processing in accordance with the present invention.

FIG. 8 is a schematic diagram showing an example of participation procedures with respect to a network game in accordance with the present invention.

FIG. 9 is a schematic diagram showing data flow between the devices in the present system.

FIG. 10 is a schematic diagram showing an example of a tactics directions screen for an object in accordance with the present invention.

FIG. 11 is a first schematic diagram for illustrating the ranking processing for the players in the present system.

FIG. 12 is a second schematic diagram for illustrating the ranking processing for the players in the present system.

### DESCRIPTION OF REFERENCE NUMERALS

1 Network
2 Arcade system
10 Game device
11 Satellite device
12 Main monitor
13 Main CPU
20 Terminal device
30 Arcade server
40 Center server
41 Race server
42 Database server

### DESCRIPTION OF EMBODIMENTS

Hereinafter, preferred embodiments of the present invention will be described with reference to the drawings.

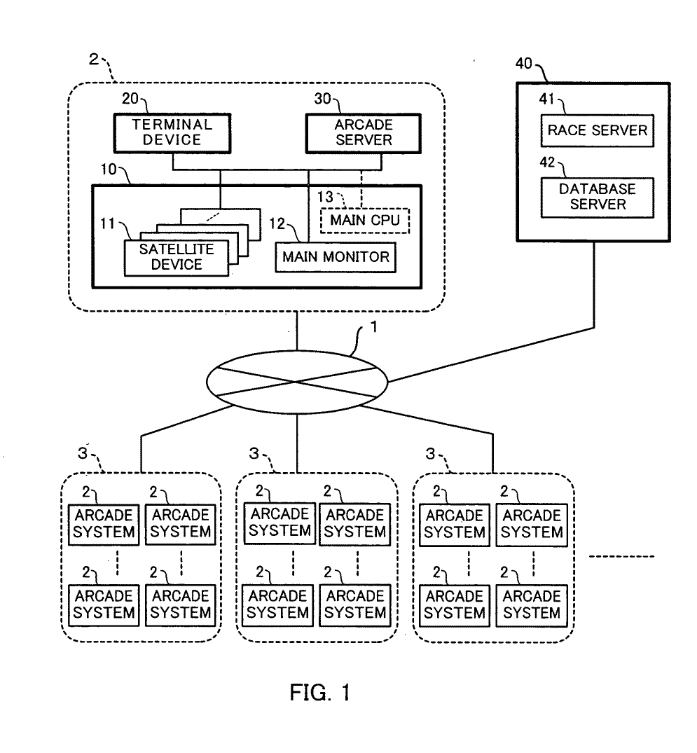

FIG. 1 is a block diagram showing an example of the overall configuration of a network game system in accordance with the present invention. First, game processing in the network game system in accordance with the present invention will be outlined.

It is important to note that the word “game” in “competing game,” “game,” “network game,” or the like in the present invention indicates a game in which characters corresponding to players execute a competition in accordance with operations undertaken by the players in order to determine victory or defeat, or a game in which a plurality of moving objects corresponding to players execute a racing game in order to determine ranking or the like among the moving objects, thereby determining any one moving object as a winner.

The network game system in accordance with the present invention (hereinafter referred to as “the present system”) is a game system which allows the data of a game character corresponding to a player (hereinafter referred to as “object data” or “object”) to compete virtually against the data of a game character corresponding to another player, determines the data which have survived the competition, executes processing which allows the data to compete against data which have survived another virtual competition a plurality of times, and determines data which have survived to the end in the executed processing as a winner.

In the present embodiment, a arcade system 2 including a game device 10 or the like installed in amusement facilities (hereinafter referred to as a “arcade”) located nationwide is connected to a center server 40 through a communications network 1, and object data which satisfy a predetermined condition in game processing executed by the game device 10 of the arcade system 2 are uploaded to the center server 40 through the communications network 1.

As object data to be uploaded to the center server 40, object data which satisfy a predetermined condition is uploaded to the center server 40 through the communications network 1 similarly from arcade systems 2 installed in arcades located nationwide.

Furthermore, when the object data are uploaded to the center server 40, a player ID of the player who uses (possesses) the object data may be uploaded to the center server 40 in connection with the object data.

Furthermore, in the center server 40, a network game tournament (hereinafter referred to as a “world race”) on the basis of a competition using object data uploaded corresponding to each arcade is executed, determining a nationwide winner in the world race.

On this occasion, in the present system, the center server 40 executes (1) a competing game for electing an object which will participate in a championship game in the arcade system 2 on the basis of the data of objects raised by the players through the operation of a satellite device 11 in the arcade system 2 (hereinafter referred to as a “arcade preliminary game”), (2) a competing game for determining a arcade representative object on the basis of the data of the object elected in the arcade preliminary game (hereinafter referred to as a “arcade championship game”), (3) a competing game for determining an area representative object on the basis of the data of the representative object of the arcade system 2 (hereinafter referred to as an “area preliminary game”) successively, and (4) through the competing games executes a competing game for determining a nationwide champion object on the basis of the data of the representative objects of each area 3 (hereinafter referred to as a “nationwide championship game”).

In the present embodiment, since the processing during the competing games is processed by a race server 41 within the center server 40, operations undertaken by the players are not basically required. Virtual competing processing is executed non working times, the result data of the competition games are stored in the database server 42, the result data are distributed to a arcade server 30 of each arcade before working times, and the images of the competition results are displayed during working times.

The virtual competing processing in the race server 40 is not necessarily executed non working times. The result data of the competing games may be calculated during working times, and may be stored in the database server 42. The result data may by distributed to the arcade server 30 of each arcade during working times.

Furthermore, in the present system, a expectation game is executed in which, under the control of the center server 40 before the nationwide championship game, a voting period is provided for predicting which object will win a prize in the nationwide championship game and voting for virtual economic values (money, points, medals, or the like) (hereinafter referred to as “preliminary voting”), and third parties predict an object which will win a prize in the nationwide championship game.

The center server 40, in the nationwide championship game, executes bonus data giving processing which gives a player who possesses the object which won the game and each player in the area to which the player belongs bonus data as a reward.

In the expectation game, the center server 40 receives the voting data of the third parties from a communications terminal (terminal device 20 in the present embodiment) within the game device 10 installed in the nationwide arcades through the communications network 1, and on the basis of the voting data and the result data of the competing game, gives a third party, whose expectation of prize-winning objects (a champion object and objects ranked in predetermined places) has proven to be true, bonus data.

Next, the configuration of the game system shown in FIG. 1 will be described.

In FIG. 1, each arcade system 2 is provided with a game system in which the game device 10, the terminal device 20, and the arcade server 30 are connected to each other through a local area network (LAN) in a mutually communicable manner. The local area network of each arcade system 2 is connected to the communications network 1, such as the Internet, through a communications control device such as a router, and the game device 10, the terminal device 20, and the arcade server 30 are connected to the center server 40 through the communications network 1 in a mutually communicable manner. The game device 10 has a communications mode which transmits/receives data to/from the center server 40 through the arcade server 30. It may also transmit/receive data to/from the center server 40 by bypassing the arcade server 30.

Another possible communications mode is to construct the center server 40, which is connected to the arcade system 2 in which devices are connected to each other through the local area network in a mutually communicable manner through the communications network 1 such as the Internet, as a VPN (Virtual Private Network) and to execute data transmission/reception between each arcade system 2 and the center server 40.

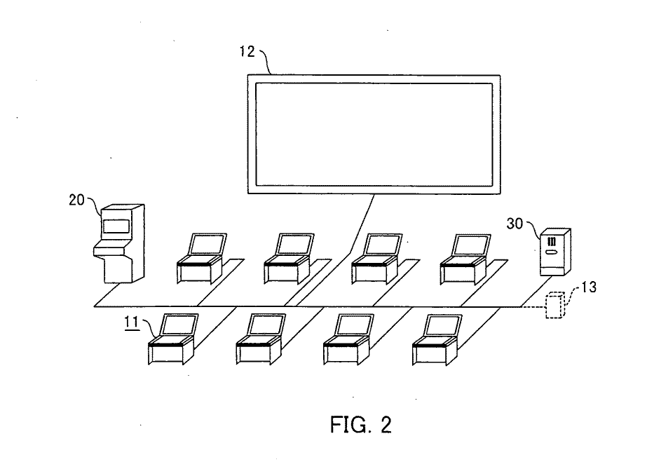

The game device 10 is, as shown in the schematic diagram shown in FIG. 2, provided with a plurality of satellite devices 11 and a main monitor 12 having a large-size display on which all the players seated at the satellite devices 11 can view game images, allowing a plurality of players in the arcade to execute a network game. As a control device in this case, a control section within the arcade server 30 (or a main CPU 13 within the game device 10) is used.

The satellite device 11 within the game device 10 is used as a game device for executing a game by which a player earns prize money by raising a player's own object or allowing the raised object to participate in a predetermined racing game. Each satellite device 11 is operable as a game device independently. In the present embodiment, the satellite device 11 is provided with means (a card processing section) for writing the data of an object raised by a player into an external storage medium (a storage medium possessed by the player) and storing such data therein.

The satellite device 11 is also used as registration means for executing the registration of objects which will participate in the above-described world race. The ID (identifier) of the object of which the registration has been directed by the player is transmitted to the arcade server 30 by the satellite device 11 through the local area network, is transmitted from the arcade server 30 to the center server 40 through the communications network 1, and is registered in the database of the center server 40. The player ID of the player who is raising the object may be transmitted to the center server 40 and registered in connection with the ID of the object to be transmitted to the center server 40.

In addition, the arcade ID (of the arcade at which the game device on which the player is executing a raising game is installed) which is stored in the arcade server 30, or the area ID corresponding to the area to which the arcade belongs may be transmitted to the center server 40, and may be registered together with its object ID and the player ID in connection with the object ID.

The participation conditions for the world race are required to satisfy predetermined conditions such as that an object corresponding to a player in a competition network game executed by the game device 10 or the like within the arcade system 2 gains a good result, that the prize money earned by the object corresponding to the object in the game exceeds a predetermined amount, and that the object corresponding to the player wins a specific racing game (for example, a graded race).

The terminal device 20 is a communications terminal operable as a terminal device of the center server 40, and is provided with means for transmitting data on tactics directions for an object corresponding to a player in the nationwide championship game in the world race to the center server 40 and means for transmitting data on the expectation voting in the above-described expectation game to the center server 40.

When tactics directions data for the object corresponding to the player is transmitted to the center server 40, the player ID corresponding to the player and the tactics directions data may be transmitted with a connection established therebetween.

The arcade server 30 is also used as a control device when executing a network game in the arcade system 2, and in the present embodiment, operates mainly as a data relay device, wherein, for example, it allows the display section of the terminal device 20 or the main monitor 12 to display a expectation voting status for a competition game on the basis of the data on the expectation voting status (the current expectation voting status obtained by totalizing the voting in all arcades) of a competition game distributed from the center server 40 or allows the display section of the main monitor 12 or the terminal device 20 to display the results of main races executed by and distributed from the center server 40.

The center server 40 is a computer system forming the core of the present system, and is provided with a race server 41 and a database server 42 for executing and managing the world race.

The race server 41 is provided, as a game processing means for the entire network game in accordance with the present invention, with progress control means for allowing a series of world races to progress successively and repeatedly on the basis of predetermined schedule data including information on the period and date fixed for the world races (in the present embodiment, being the arcade preliminary game, the arcade championship game, the area preliminary game, and the nationwide championship game), which are competition game tournaments between data of each object, and world race processing means for executing competition games between arcades and between areas under the control of the progress control means. The race server 41 is further provided with object control means for, when the player ID corresponding to the object participating in the world race and the tactics directions data corresponding to the player ID are registered in the database server, executing control for changing the motion of the object during the competition game.

The database server 42 is a server for storing various kinds of data required for a network game executed by the race server 41 in the database in connection with various kinds of identifiers (hereinafter referred to as “ID”), and is provided with a database shared with the race server 41.

In the present embodiment, the database server 42 is provided with participation condition judgment means for uploading the data of objects for which the registration for the participation in the world race is directed by each player from the storage section of the satellite device 11 in a predetermined time zone (in the present embodiment, non businessnon working times of the arcade: for example, midnight) and executing processing for storing the data of objects judged to satisfy the participation conditions in the database.

The registration of the participation in the world race by each player is not limited to the above-described uploading method which uploads to the database server 42 in a predetermined time zone collectively. A method may be applied in which the satellite device 11 is provided with participation condition judgment means for judging whether the data of the object satisfy the participation conditions for the world race, and when it is judged that the participation conditions are satisfied, it is uploaded to the database server 42 successively. The participation condition judgment means judges whether or not the participation conditions for the world race are satisfied by comparing the race record of the object (race record in competition games executed in a arcade, acquired prize money data in competition games executed in a arcade, winning data in specific races in competition games executed in a arcade, or the like) with conditions data.

The race server 41 executes the world race using the data of the objects stored in the database server 42.

The database server 42 is, in addition to the above-described participation condition judgment means, provided with data storage means for storing the data of the object which is judged to satisfy the participation conditions for the world race, tactics data for the object which will participate in each world race, the data of competition results, or the like in the database in connection with IDs for discriminating various kinds of data (in the present embodiment, player ID, object ID, arcade ID, and area ID) and distribution means for determining a target to be given bonus data on the basis of the preliminary voting data in the expectation game and the result data of the nationwide championship game, and distributing the player ID, arcade ID, and the area ID of the target to each arcade server 30.

The database server 42 is further provided with means for distributing the result data of main races to the arcade server 30 of each arcade and means for generating expectation voting status data indicting the current expectation status on the basis of the voting data of all arcades and distributing the expectation voting status data to the arcade server 30 of each arcade.

The target to be given bonus data includes, in the present embodiment, a player who is the owner of an object which won the nationwide championship game, each player in the area to which the player belongs, each player in the arcade in which the player was registered when the player participates in the world race, and a person whose expectation for prize-winning horses in the nationwide championship game has come true. In the present embodiment, the satellite device 11 writes the bonus data into the external storage medium possessed by the target to be given the bonus data.

Next, the hardware configuration of the main devices installed in a arcade will be described. First, the hardware configuration of the satellite device 11 within the game device 10 will be described.

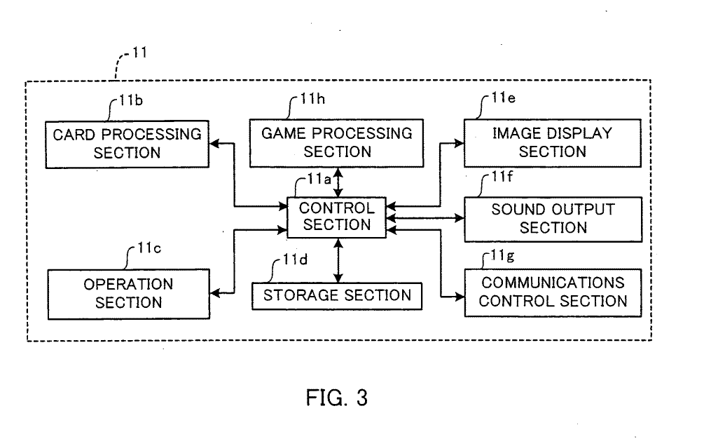

FIG. 3 is a block diagram showing an example of the internal structure of the satellite device 11. Each satellite device 11 is provided with a control section 11a, a card processing section 11b, an operation section 11c, a storage section 11d, an image display section 11e, a sound output section 11f, a communications control section 11g, and a game processing section 11h.

The control section 11a comprises a CPU (Central Processing Unit) and executes the execution control of a computer program and input/output control with respect to peripherals through an input/output interface. The card processing section 11b is provided with two card reader/writers, and in the present embodiment, makes the data of an owner card and a horse card, which will be described later, accessible (in the present embodiment, both are IC cards), with both cards installed simultaneously. The operation section 11c in the present embodiment comprises an information input device comprising a touch panel provided on the surface of a display. The operation section may comprise, instead of the touch panel, operating means comprising operating switches and buttons to be pressed. The storage section 11d comprises predetermined storage media such as a ROM (Read Only Memory) and a RAM (Random Access Memory). The image display section 11e comprises a display device such as a liquid crystal display (LCD) and a CRT (Cathode Ray Tube), and a sound output section 11f comprises a sound output device such as a sound circuit and a speaker. The communications control section 11g comprises a data transfer control circuit to control the communications with the center server 30 through a communications network. The game processing section 11h comprises a game program and an image processing device such as a GPU (Graphics Processing Unit).

Next, the terminal device 20 within the game device 10 will be described. The hardware configuration of the terminal device 20 comprises, though not shown, as in the case of the hardware configuration of the satellite device 11, a control section comprising a CPU for executing the execution control of a game program and executing input/output control with respect to peripherals through an input/output interface and a card processing section which is provided with two card reader/writers, and makes the data of an owner card and a horse card, which will be described later, accessible (both are IC cards), with both cards installed simultaneously. The storage section comprises predetermined storage media such as a ROM and a RAM. The image display section comprises a display device such as a liquid crystal display and a CRT, and the sound output section comprises a sound output device such as a sound circuit and a speaker. The communications control section comprises a data transfer control circuit to control the communications with respect to the center server 40 and the arcade server 30 through a communications network. The game processing section comprises a game program and an image processing device such as a GPU. The operation section of the terminal device 20 in the present embodiment comprises an information input device such as a touch panel provided on the surface of a display.

The arcade server 30 and the center server 40 have, respectively, although not shown, a configuration similar to a general server. Each of the servers is provided with a control section comprising a CPU for executing the execution processing of a game program and executing input/output control with respect to peripherals through an input/output interface, a storage section comprising predetermined storage media such as a ROM and a RAM, a communications control section comprising a data transfer control circuit to control the communications with respect to each server and the game device 10 through a communications network, and a game processing section comprising a game program and an image processing device such as a GPU.

In the above-described configuration, the network game processing method in accordance with the present invention will be described in detail with reference to examples provided.

An in-depth description of the processing which has been described will be omitted or described simply. Each means of the race server 41 within the center server 40 and each means within the database server 42 will be collectively described as the game processing means of the center server 40

Furthermore, programs allowing the computer of the center server 40 to function as the game processing means are stored in a predetermined storage medium of the center server 40. A program allowing the computer of each device in a arcade to function as appropriate means are stored in a predetermined storage medium of the center server 40 also, and when a change is made to software, it is distributed from the center server 40 to each arcade system 2 in the nationwide arcades, and can be downloaded as required by the computer of each device of the arcade system 2 in the nationwide arcades.

First, the progress of a nationwide competition game tournament in accordance with the present invention will be described.

In the present embodiment, as described above, aside from the usual competition game using a arcade local area network executed by the game device 10 installed in the arcade system 2 or a raising game executed by the satellite device 11, a meeting executing a nationwide competition game tournament using the communications network 1 such as the Internet is held. The object data of a player participating in the meeting are object data raised by the player itself in the present embodiment. The “object” in this instance is an individual character representing an arbitrary competing object such as a racehorse, an athlete, a fighter, or virtual life or an object for a competition game representing the entire team consisting of a plurality of characters.

Hereinafter, an embodiment will be described in which, taking a case in which the objects are “racehorses” as an example, a virtual horse race tournament is executed as the world race.

In the present embodiment, the center server 40 manages the world race for the arcade system 2 installed in nationwide arcades, with the period fixed for one world race set to be a week, and regards the arcade preliminary game, the arcade championship game, the area preliminary game, and the nationwide championship game as a flow, and executes the world race allowing a competition by the data of racehorses raised by the players to be held every week.

The data of racehorses participating in the world race are, in the present embodiment, the data of racehorses which won a graded race out of virtual horse races executed in the arcade.

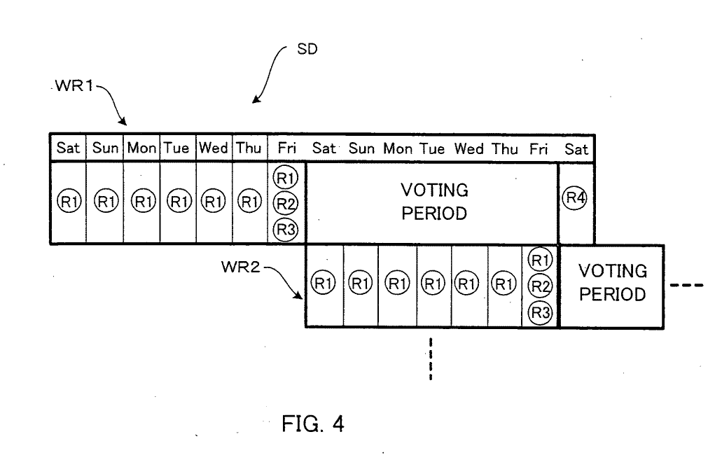

FIG. 4 is a schematic diagram showing schedule data for use in the management and progress control of the world race. Schedule data SD including the day fixed for a arcade preliminary game R1, a arcade championship game R2, an area preliminary game R3, and a nationwide championship game R4 is stored in the database of the center server 40. The game processing means of the center server 40 allows the world race to automatically progress on the basis of the schedule data SD shown in FIG. 4.

In the example shown in FIG. 4, from Saturday through to Friday next week (for a week), a virtual horse race is executed every day, and representative horses on each day of the week (for example, two horses) are determined. The data of racehorses for use in the horse race are the registration data (hereinafter referred to as “participating horse data”) of the racehorses which won graded races held within the working times of the day, and is, in the present embodiment, participating horse data which were uploaded by the game processing means of the center server 40 from the storage section of the satellite device 11 non working times and was stored in the database.

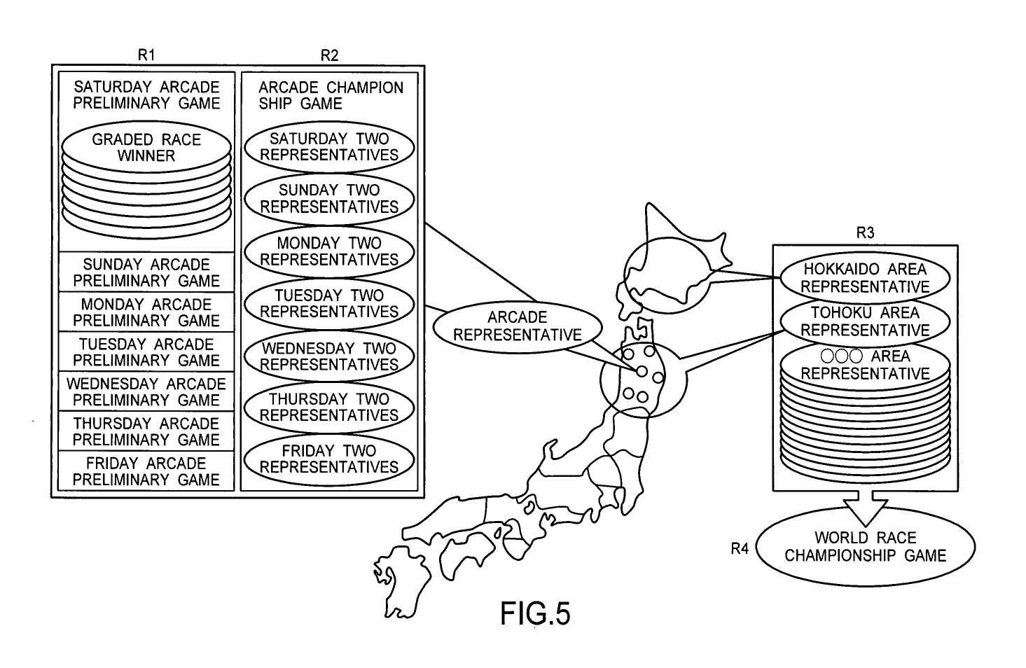

When a representative horse on each day of the week is determined throughout the week-long arcade preliminary game R1, the game processing means of the center server 40 then executes, as shown in FIG. 5, horse races for the arcade championship game R2 using participating horse data representing each day of the week and the area preliminary game R3 using the participating horse data representing each arcade, for example, on the day when the arcade preliminary game R1 has ended (Friday in the present embodiment). In the example shown in FIG. 5, the nationwide area is divided into wide areas such as “Hokkaido area” and “Tohoku area.” The areas may be on a prefecture-by-prefecture basis or on sections obtained by further dividing the area of the prefectures. Combining those areas, the horse race of the area preliminary game R3 may be executed in a plurality of stages from narrower areas to wider areas.

When the participating horse data representing each area are determined by the horse race of the area preliminary game R3, the game processing means of the center server 40 then, with the next week as the voting period for preliminary voting, executes the reception processing of the preliminary voting and data generation processing of the expectation voting status (the current expectation voting status obtained by tallying the voting of all arcades) successively, distributes the data indicating the expectation voting status to a display device (the terminal device 20 in the present embodiment) of each arcade, and allows its displays section to display the current expectation voting status.

The game processing means of the center server 40 ends the reception of the preliminary voting at a predetermined time (the voting end time set in the schedule data SD) on the last day of the voting period, and then executes the horse race of the nationwide championship game R4.

In the present embodiment, as shown in FIG. 4, in parallel with the week-long voting period, the horse races of the arcade preliminary game R1, the arcade championship game R2, and the area preliminary game R3 of the next time world race are executed. According to such a flow, the processing for executing the world race every week is repeated. The cycle for executing the world race and schedule such as the day and time fixed for each horse race can be freely changed by changing the setting values of the schedule data SD from the management terminal or the like.

The processing for horse races from the above-described arcade preliminary game R1 to the nationwide championship game R4 is executed non working times, the image of each horse race and news of the race results will be then broadcast in the arcade during working times. Specifically, image data showing the progress of the horse race and text data or the like concerning the commentary of the race result or the like are generated by the center server 40, and the image data, the text data, and the race result data are stored in the database of the center server 40, and are distributed from the center server 40 to the arcade server 30 of each arcade, for example, non working times (or during working times) of each day. The progress of the horse race (for example, the progress of a race set as an important race) is displayed on the display section of the display devices including the main monitor 12 of each arcade within the arcade server 30 during the working times of each day.

The data generated by the center server 40 may be limited to the race result data showing the whole horse race (from start to end), and the image data showing the progress of the race and the text data concerning the commentary of the race result or the like may be generated by the processing means of the arcade server, and may be displayed on the display section of the main monitor 12 installed in each arcade system 2 or the display device of each display device.

### <Images During a Race>

Images generated during a race and displayed on the display device of each arcade will now be described.

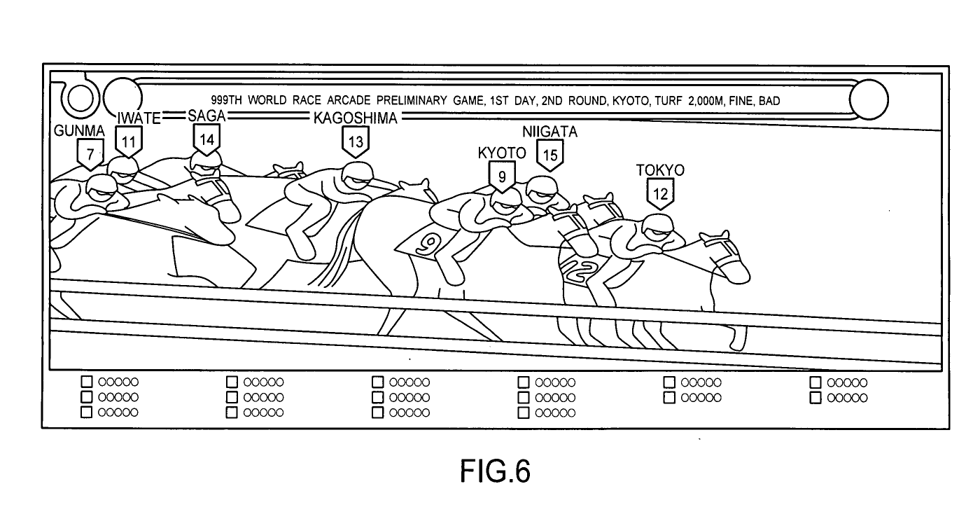

FIG. 6 is a picture showing a screen example of a horse race shown on the main monitor 12 of the arcade system 2 installed in the nationwide arcades. The present example indicates the progress of the race in the nationwide championship game by images and character strings such as commentaries, and on the basis of the area ID and the player ID corresponding to each object data, on the head or above the back of the jockey of each participating horse representing each area, an area to which the owner (the player who has raised the participating horse) of the participating horse belongs is displayed. Such a display manner can illustrate progress in which, for example, a horse carrying “Niigata” on its back and a horse carrying “Kyoto” on its back are close behind a horse carrying “Tokyo” on its back. As a result, it can be discerned at first sight which horse is representing which area, and the progress of the horses from the various areas can be conveyed to the players more intuitively. Moreover, local awareness of each player belonging to each area can be invoked.

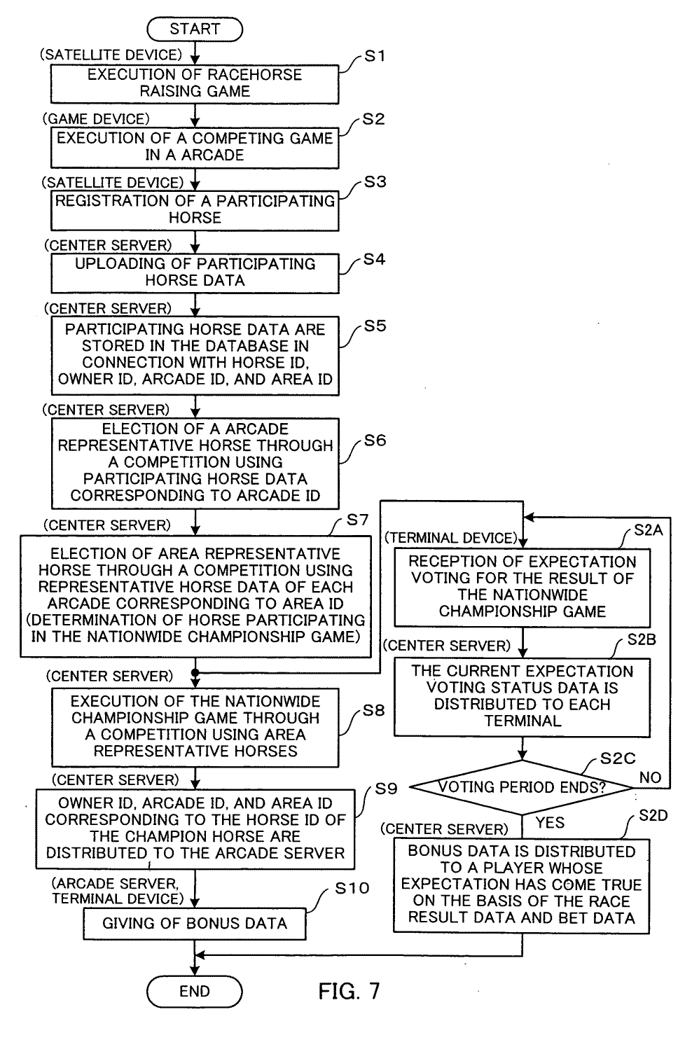

Next, main game processing in accordance with the present invention, including various kinds of operation examples of a player, will be described in line with the flowchart shown in FIG. 7.

### (Execution of a Racehorse Raising Game)

A player executes a racehorse raising game using the satellite device 11 installed in the arcade, and raises a player's own racehorse using a virtual racehorse stable and pasture. The game processing section of the satellite device 11 generates data including the current ability of a racehorse raised by training and feeding, and stores racehorse data, in which the data are connected with the player ID and the horse ID by the card processing section of the satellite device 11, in a storage medium (an IC card in the present embodiment).

In the present embodiment, the storage medium for the racehorse data includes a first storage medium (hereinafter referred to as “horse card”) for storing the ability of a racehorse and a second storage medium (hereinafter referred to as “owner card”) for storing history data such as the race record of each racehorse possessed by the player. The horse card stores the horse ID and the ability data for each card (or one card), and the owner card stores the player ID, the horse ID of each racehorse possessed by the player, and the history data (Step S1).

These card media are, in the present embodiment, issued by a card issuing machine (not shown). The data may be stored in commercial, general storage media (such as CD-ROMs, DVD-ROMs, and flash memories), or may be stored in three or more storage media. Alternatively, the ability data of a racehorse and history data such as the race record of each racehorse possessed by the player may be stored in one storage medium.

The ability data stored in the horse card will now be described. Ability parameters of a racehorse include, stamina, speed, technique (such as an overtaking skill), type (such as the front-runner type and the stretch-runner type), and race records including rank (the evaluation level of the racehorse determined by the record of the past races). Information in rank is used as a condition as to whether or not the racehorse is permitted to participate in the world race.

In the present embodiment, aside from the world race, the game processing section of the game device 10 (the arcade server 30 or the satellite device 11) executes a virtual horse race using racehorse data corresponding to a plurality of players in a arcade (Step S2), and when it is judged that a racehorse of a player has won a graded race therein, a rank value indicating that the participation condition for the world race is satisfied is set, the control section of the satellite device 11 allows the display section of the satellite device 11 to display an image indicating that the participation condition for the world race is satisfied, and a determination about the participation in the world race in accordance with operational input to the operation section of the satellite device 11 is then received by the player.

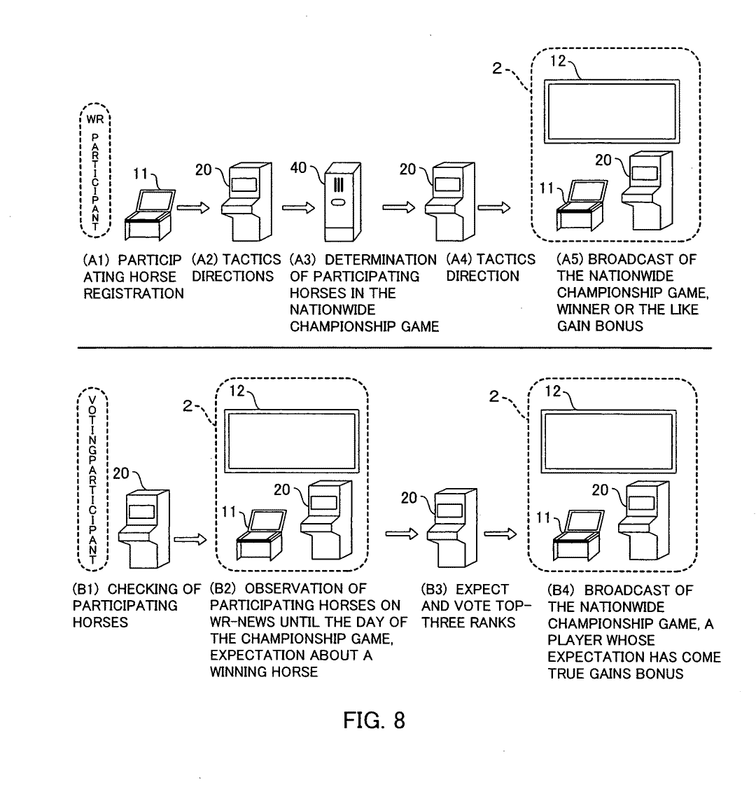

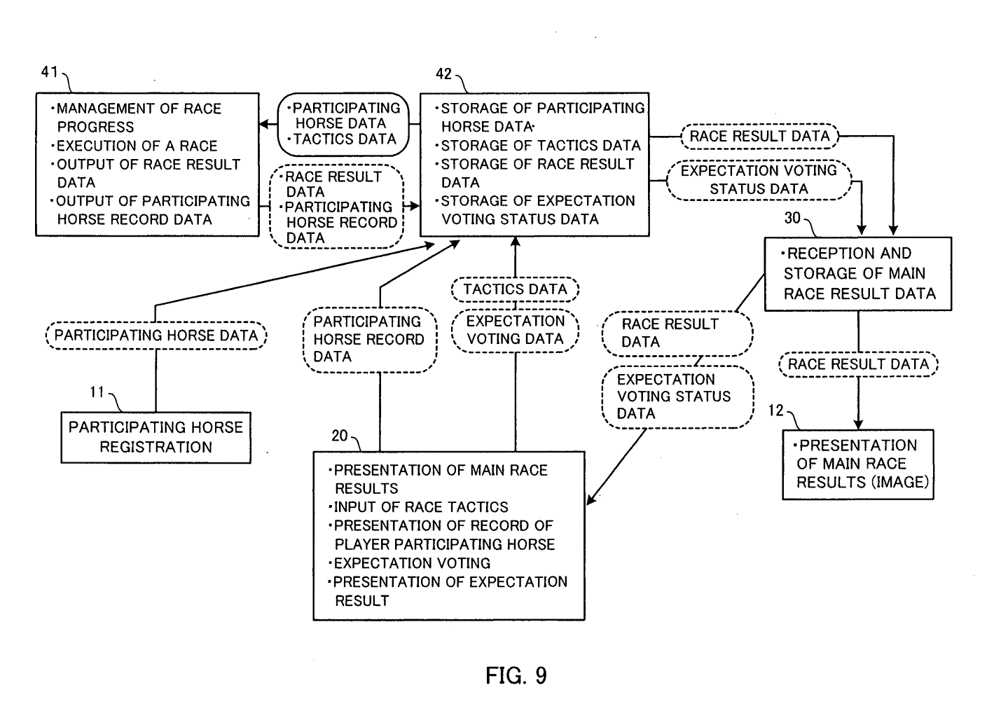

FIG. 8 is a schematic diagram showing an example of participation procedures for a network game participant in accordance with the present invention, and shows the flow of terminal operations for a world race participant (hereinafter referred to as “WR participant”) and a preliminary voting participant (hereinafter referred to as “voting participant”). FIG. 9 is a schematic diagram showing data flow between the devices in the present system. Hereinafter, description will be given with reference to FIGS. 8 and 9.

### (Participating Horse Registration)

When a WR participant allows a racehorse to participate in the world race, the WR participant, as described above, allows the display section of the satellite device 11 to display that the participation condition for the world race is satisfied, and performs a registration directive in accordance with operational input to the operation section. On this occasion, the horse card in which the participating racehorse data raised by the satellite device 11 in advance is stored and the owner card are inserted into the card processing section of the satellite device 11 (in the case of a noncontact IC card, it is held over a reading section). Through the directive, the data including the player ID stored in the owner card, the horse ID stored in the horse card, and rank information are read by the card reading section of the satellite device 11, and are transmitted to the center server 40 by the communications control section of the satellite device 11 through the local area network within the arcade system 2 and the communications network 1. The game processing means of the center server 40 compares the rank data with the condition data (data indicating a minimum rank value allowing participation) to judge whether or not the participation condition for the world race is satisfied, and when the participation condition is satisfied, the player ID, the horse ID, and registration date are stored in the database as registration information, and a registration completion message is returned to the satellite device 11, completing the registration processing. The control section of the satellite device 11 allows the image display section to display an image indicating registration completion, discharges the owner card and the horse card by the card processing section in order to return them to the player, thereby completing the overall registration processing (Step S3).

The racehorse data registered in the registration processing in Step S3 are stored in the storage section of the terminal device 20 as participating horse data. Hereinafter, an example will be described in which the participating horse data are transferred to the storage section of the arcade server 30 before the upload processing on the participating horse data by the center server 40.

### (Uploading of Participating Horse Data)

The game processing means of the center server 40, on the basis of the registration information stored in the database, allows the participating horse data stored in the storage section of the arcade server 30 of each arcade to be uploaded (Step S4), and stores the participating horse data in the database in connection with the horse ID, player ID, arcade ID, and area ID (Step S5).

As shown in FIG. 9, the participating horse data may be uploaded from the storage section of the terminal device 20.

### (Election of Arcade Representative Horse)

The game processing means of the center server 40, in accordance with the schedule set in the schedule data, executes a arcade preliminary game using each participating horse data corresponding to each arcade ID, determines a representative horse on the day of the week of each arcade, and stores the race result data of the arcade preliminary game in the database.

When tactics direction data are input by the player through the tactics direction means provided in the terminal device 20, the tactics data may be stored in the database (See FIG. 9) in order to change the motion of the object in accordance with the tactics data. When it is set that a race image is not required to be displayed in the arcade, image processing on the arcade preliminary game may not be executed, and only the computation on the race result may be executed. As described above, only the computation on the race result may be executed, the race result data may be distributed to the arcade server 30, image processing on the arcade preliminary game may be executed, and a race image may be displayed in the arcade. This processing will be repeated until a representative on the day of the week is determined.

The game processing means of the center server 40, after the determination of the representative horse on the day of the week, repeats the processing for determining a representative horse on each day of the week in accordance with the schedule set in the schedule data, executes a arcade championship game using each participating horse data corresponding to the horse ID of a representative horse on each day of the week on the day when a week-long arcade preliminary games R1 has ended, stores the data of the horse which won the arcade championship game in the database as the data of the arcade representative horse, and ends the election processing for the arcade representative horse (Step S6).

### (Inputting of Tactics Data)

Data on tactics directions will now be described by showing a screen image of the terminal device 20.

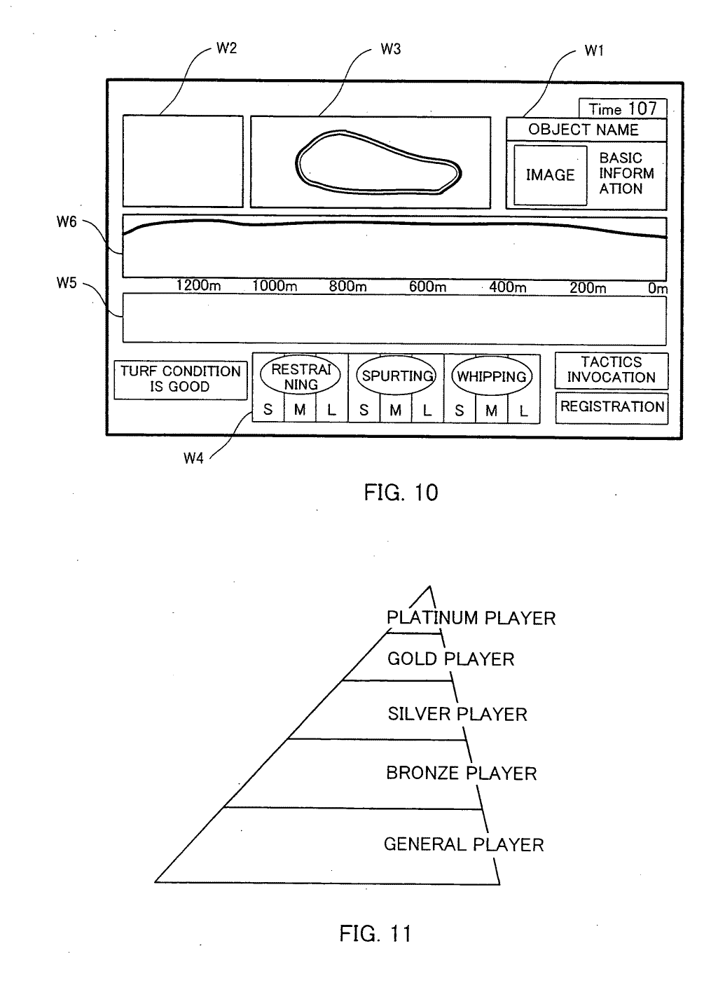

FIG. 10 is a schematic diagram showing an example of a tactics directions screen displayed on the touch panel display section of the terminal device 20. On the tactics directions screen, the contents of the horse data stored in the horse card are displayed on display windows W1 and W2, and a reduced figure showing the course of a racetrack in three dimensions is displayed on a display window W3. Within the display window W2, for the contents with respect to ability, for example, starting skill, cornering ability, horse-group breaking ability, competing ability, toughness, and explosiveness are indicated by a bar graph. Within a display window W4, with “restraining,” “spurting,” and “whipping” set as operational elements for a participating horse, a direction amount for each operational element can be set in a plurality of stages such as “small,” “medium,” and “large.” Furthermore, in the present embodiment, the direction in which these operations are executed can be directed. For example, a touch operation on the reduced figure shown on the display window W3 or a touch operation on a part of a certain distance in the distance information displayed on a display window W5 can designate what distance which operational element is used, and provide a direction amount for the operational element.

The control section of the terminal device 20, when tactics directions are issued, executes simulation processing on a virtual horse race on the basis of the direction data, course topographic data, environmental data indicating turf condition or the like, and the ability data of the participating horse. Fatigue of the horse when directions are issued is predicted in real time, and, as shown within a display window W6 in FIG. 10, the fatigue of the horse is displayed by a graph, with the horizontal axis being distance and the vertical axis being the amount of fatigue (resulting in a decreased amount in the ability parameter value of the associated horse data). The player sees the graph display by this simulation processing and can adjust directions such as each operational element and a direction amount for each operational element (See (A2), (A4) in FIG. 8). These tactics directions are not essential, and when no direction data are input, the center server 40 controls the motion of a participating horse on the basis of standard direction data set in the storage section of the center server 40 in advance.

### (Election Processing for Area Representative Horses)

When the election of the arcade representative horse ends in Step S6, the game processing means of the center server 40, in accordance with the schedule set in the schedule data, executes the area preliminary game using participating horses corresponding to the horse ID of each arcade representative horse. This area preliminary game is also, as in the case with the arcade preliminary game and the arcade championship game, a competition game tournament in which participating horse data corresponding to the horse ID of each arcade representative horse executes a virtual horse race, and participating horse data which won the virtual horse race repeatedly executes virtual horse races. Representative horses (16 in the present embodiment) which have survived each horse race executed for each area ID are determined as area representative horses (See (A3) in FIG. 8), and the election processing for area representative horses ends (Step S7).

### (Broadcast Processing for the Nationwide Championship Game)

The game processing means of the center server 40, when the election processing for area representative horses ends, in accordance with the schedule set in the schedule data, executes the nationwide championship game by the area representative horse data, stores its race result data in the database, then distributes the race result data of the nationwide championship game to the arcade server 30 of each arcade (or transmits it on demand from the arcade server 30), for example, on weekends, and on the basis of the race result data, allows the main monitor 12 installed in the nationwide arcade system 2 to display it (Step S8).

### (Bonus Data Giving Processing)

When the nationwide championship game ends, the game processing means of the center server 40 distributes the result data of the nationwide championship game to each arcade server 30 of the nationwide arcades. On this occasion, the game processing means of the center server 40 distributes the player ID corresponding to the horse ID of the participating horse which won the nationwide championship game and the arcade ID corresponding to the player ID, and the area ID corresponding to the arcade ID together with the result data of the nationwide championship game to each arcade server 30 of the nationwide arcades (Step S9).

Each arcade server 30, which has received the result data of the nationwide championship game and each ID data, compares a player's own arcade ID with the received arcade ID, and when they match each other, judges that a winner has occurred in a player's own arcade, and distributes an intra-arcade winner occurrence/notification message including information indicating the fact and the player ID to each satellite device 11, the main monitor 12, and the terminal device 20. Each satellite device 11, the main monitor 12, and the terminal device 20 which have received the intra-arcade winner occurrence/notification message, on the basis of image data stored in the storage section of each device in advance, change the image processing to the one used when a winner occurs in a player's own arcade, and display a specific image corresponding to the case when a winner occurs in a player's own arcade. The image data when a winner has occurred may be demanded from the arcade server 30 by the center server 40 when the player ID matches.

Meanwhile, when the arcade server 30 judges that the arcade ID does not match, the arcade server 30 compares the area ID received next with the area ID corresponding to a player's own arcade ID, and when they match each other, judges that a winner has occurred in a player's own area, and distributes an intra-area winner occurrence/notification message including information indicating the fact and the player ID to each satellite device 11, the main monitor 12, and the terminal device 20. Each satellite device 11, the main monitor 12, and the terminal device 20 which have received the intra-area winner occurrence/notification message change the game progress state from a normal state into a special bonus state, and execute processing corresponding to the special bonus state, respectively. The contents of the special bonus state in the present embodiment, include, for all the display devices in the arcades belonging to the area, displaying contents representing congratulation (for example, the names of the player and the winning horse, congratulatory wording, and the name of a platinum player on the wall of the course) on the race screen on the main monitor 12 or the like during the virtual horse racing game using each horse data in the arcade, and displaying a congratulatory image on the screen of the satellite device 11 during the execution of the raising game by the satellite device 11.

The control section of the satellite device 11 which has received an intra-arcade winner occurrence/notification message or an intra-area winner occurrence/notification message, when the owner card is inserted into the card processing section of the satellite device 11 by the player, compares the player ID read from the owner card with the player ID within the intra-arcade winner occurrence/notification message or the intra-area winner occurrence/notification message, and when they match each other, judges it to be the owner of the nationwide winning horse, adds the below-described points information (hereinafter referred to as “club points”) read from the owner card, and executes the bonus data giving processing for updating the club points of the owner card.

Meanwhile, when it is judged that they do not match each other (when changed into the special bonus state), the control section of the satellite device 11 recognizes that the player possessing the owner card is, though not the owner of the nationwide winning horse, a player who belongs to the same area as the owner of the nationwide winning horse, executes the bonus data giving processing for updating the club points with less added value than that of the winner, and ends processing for giving the bonus data (Step S10). Specifically, processing for updating is performed so that the club points to be gained in the game are doubled (or more) during a certain period (for example, a period until the next world race winner is determined), and the bonus data giving processing ends.

As the points to be given as the bonus data, in the present invention, for example, the club points are used as an evaluation element for the game record of each player executing the game by the game device 10 in the arcade system 2 installed in the nationwide arcades (when the player won the above-described arcade preliminary game, the arcade championship game, the area preliminary game, or the like, when the player won the above-described nationwide championship game, or when the player's expectation has come true in the above-described expectation voting (the expectation game)). The club points are virtual-money-like points (valuable information) for purchasing items for use in the above-described raising game.

By executing the above-described processing of Step S9 and Step S10, not only the player (winner) possessing the winning horse but also other players belonging to the arcade to which the winner belongs, and each player which belongs to the area to which the arcade belongs can gain club points (See (A5) in FIG. 8). Players participating in the world race may be given an added point as a point for participation (the reception processing for preliminary voting).

Next, processing for the expectation game will be described. The game processing means of the center server 40 executes the reception processing for the preliminary voting. Hereinafter, operation by a voting participant will be mainly described with reference to (B1) to (B4) shown in FIG. 8.

### (B1) Checking of Participating Horses

The voting participant operates the terminal device 20 to check the participating horses. The control section of the terminal device 20 allows the display section of the terminal device 20 to display, for example, a schedule screen indicating the schedule of each race. When the “details” button of the race is pressed (a touch operation by a finger or the like in the present embodiment), in accordance with the operational input, the control section of the terminal device 20 allows the display section of the terminal device 20 to display the details of the race contents and the race result screen.

On this occasion, when the area preliminary game (the virtual horse race) for determining an area representative by the representative horse data of each arcade corresponding to the area ID has been ended by the center server 40 and the participating horses for the nationwide championship game have been determined, the control section of the terminal device 20 allows the display section of the terminal device 20 to display a list of the participating horses for the nationwide championship game on the basis of the data on the participating horses for the nationwide championship game stored in the database of the center server 40.

When the voting participant further presses the “details” button of a certain participating horse displayed on the display section of the terminal device 20, information on the ability, pedigree, or the like of the participating horse is further displayed on the display section of the terminal device 20 on the basis of the data on the participating horse stored in the database of the center server 40, thereby allowing the voting participant to check information necessary for voting.

Furthermore, on the basis of the data on the participating horse stored in the database of the center server 40, the past race results of the horse participating in this time nationwide championship game can be checked. The display processing is preferred to be executed by the arcade server 30 on the basis of the race result data distributed from the center server 40, and may be executed by the terminal device 20 on the basis of the race result data distributed from the center server 40 and stored in the arcade server 30.

(B2) Expectations about a Winning Horse

The news about the world race is broadcast until the day of the championship game to the display section of the satellite device 11 and the main display 12 within the nationwide arcades on the basis of the race result data distributed from the center server 40 to the arcade server 30 of each arcade. The data on this news are transmitted from the arcade server 30 to each device within the arcade system 2 on the basis of the race result data distributed at appropriate times from the center server 40 to the arcade server 30 of each arcade, and the control section of each device displays it on the display section of each device. The voting participant can observe the participating horses which will participate in the nationwide championship game through the news distribution, and predict a winning horse in the nationwide championship game of the world race.

### (B3) Expectation Voting for a Winning Horse in the Nationwide Championship Game

The voting participant predicts the ranking of the race horses which will participate in the nationwide championship race during the voting period (in the present embodiment, during the above-described arcade preliminary game, arcade championship game, and area preliminary game), and inputs information on expectation voting (in the present embodiment, expectation information of the top three horses) through directional operation on the screen of the terminal device 20. On this occasion, a screen for placing a virtual bet (money, points, a medal, or the like) is displayed on the display section of the terminal device 20. The voting participant inputs information on the bet through a directional operation on the screen. The control section of the terminal device 20, when the voting direction for expectation voting is performed by the voting participant, generates expectation voting data including the expectation information, the bet information, and the ID information read by the card processing section of the terminal device from the owner card, and transmits it to the center server 40.

The virtual bet may take other forms, for example, allowing the voting participant to purchase a bet using club points stored in the owner's card and to purchase a bet at a sales site provided by the center server 40.

Furthermore, the center server 40 which has received the preliminary voting data may calculate the statistical information on the placing expectation of the participating horses and odds information on the basis of the expectation voting data and the expectation voting data which has been received from the nationwide arcades so far, may generate the current expectation voting status data, and may transmit it to the arcade server 30.

The arcade server 30 to which the current expectation voting status data have been transmitted may transmit the expectation voting status data to the terminal device 20, and may, for example, allow the split screen of the display section of the terminal device 20 to display it in real time, or to display it in accordance with the operation of the terminal device 20 by the player (Step S2A and Step S2B).

The center server 40 receives the expectation voting from the terminal device 20 until the above-described voting period ends, and executes the processing for the nationwide championship game (Step S2C).

### (B4) Giving of Bonus Data to a Player Whose Expectation has Come True

When the game processing means of the center server 40 distributes the result data of the nationwide championship game to the arcade server 30 of the nationwide arcades, the game processing means distributes it with each player ID of the player whose expectation has come true added. The bonus data for the player whose expectation has come true are, for example, a special item for use in the raising game (an item for adding parameter values such as a growth rate and ability rather than normal feed data for adding parameters for racehorse data such as a growth rate and ability by feed data for use in the raising game), and are in the present embodiment, area-specific feed data in the area to which the player belongs (the area specified by the area ID corresponding to the player ID). This bonus data are written into the owner card (or the horse card).

For the judgment processing for the player whose expectation has come true using the player ID and the timing for writing into the owner card, as in the case with the processing in Step S10, each arcade server 30 which has received the result data of the nationwide championship game and each ID data compares a player's own arcade ID with the received arcade ID, and when they match each other, judges that a player whose expectation has come true has occurred in a player's own arcade, and distributes a notification message about a expectation right including information indicating the fact and the player ID to each satellite device 11, the main monitor 12, and the terminal device 20.

The control section of the satellite device 11 which has received the message about the expectation right, when the owner card is inserted into the card processing section of the satellite device 11, compares the player ID read from the owner card with the player ID within the notification message, and when they match each other, judges it to be the player whose expectation has come true, executes the expectation right bonus data giving processing for storing area-specific feed data in the storage section of the owner card. On completion of writing of the bonus data into the owner card, the bonus data giving processing for the player then ends (Step S2D).

By providing above-described expectation game, even players who have been defeated in the preliminary stages for the nationwide championship game and player whose racehorse does not satisfy the participation condition can participate in the world race in another form, thereby allowing more players to participate in the world race and enjoy it.

FIG. 11 is a schematic diagram showing the ranks of the players. This is an example of ranking them in a plurality of ranks in a pyramidal manner, that is, the higher the rank, the fewer the number of players. In the present embodiment, the ranking is formed in connection with the score (information different from the above-described club points) of each player with the names of platinum players, “gold player”, “silver player”, “bronze player”, and general player listed in descending order from the apex of the pyramid.

As a specific bonus, in the present embodiment, after the satellite device 11 reads the ranking information of the owner card, a specific area on the display screen of the satellite device 11 is displayed with a color which is different from usual in accordance with their rank, or the lighting color of a display means (an illuminator) is displayed with a color in connection with their rank. In addition, a special owner card may be issued, in which the color or design (or both) of the card surface differs from a normal owner card.

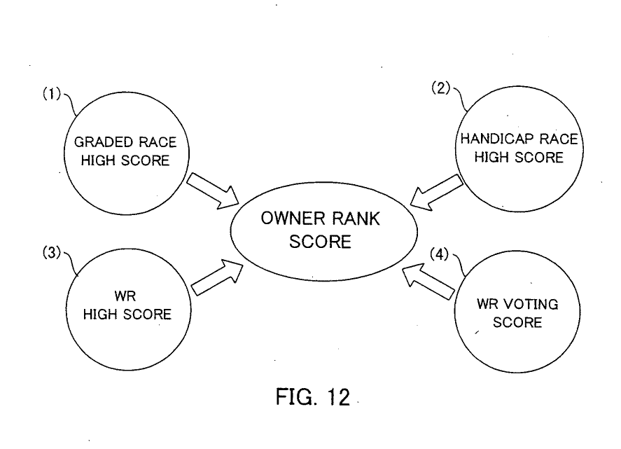

In the present embodiment, evaluation elements for ranking the players include, as shown in the schematic diagram shown in FIG. 12, (1) Graded race score (a record of graded races in the horse races in the arcade), (2) Handicap race score (a record of handicap races in the horse races in the arcade), (3) WR high score (a record of a racehorse corresponding to a player in the world race), and (4) WR voting score (the number of expectation rights or a expectation right rate for a winning horse or the like in the expectation voting in the world race), thereby allowing even a player with a lower play times to aim at a higher ranking.

The owner rank of the player who won the above-described nationwide championship game may be ranked as a “platinum player” regardless of their rank prior to the win.

In this case, the game processing means of the center server 40 totalizes the owner rank value of the nationwide players (owners), for example, week-by-week (on one world race basis), and on the basis of the totalization information and the owner rank values of the players, determines the rank of the players in decreasing order of owner rank value, and thereby ranks the nationwide players.

This allows the player who won the world race to be ranked higher in accordance with its record among the nationwide players, and allows the desire of such player to flaunt his or her achievements.

### Other Embodiments

Although the above-described embodiments have been described taking a case applied to a horse race simulation game as an example, the present invention is not limited to this kind of game, and can be applied to various kinds of computer games in which a plurality objects compete to contend for ranking. It can be also applied to a game of the type that allows teams to compete.

In addition, the object data are not limited to raising data provided by the raising game, and can be data which can compete on a network. Although in the above-described embodiments the storage medium in which the object data are stored is described taking an external storage medium as an example, the external storage medium may be replaced with a storage section of the arcade server or the center server. Furthermore, although in the above-described embodiments the IC card is taken as an example for the external storage medium storing the object data or the like, the IC card may be replaced with a noncontact IC card, a flash memory, a rewritable magnetic card (a magnetic card of which the surface printing is rewritable), or the like.

1. A network game system for executing a competing game using a network, comprising:
a arcade system in which a game device provided with a card processing section which reads at least one player ID from an external storage medium possessed by a player or writes data into said storage medium and a arcade server are connected to each other in a mutually communicable manner; and a center server which is connected to said arcade system installed in each of a plurality of arcades through a communications network in a communicable manner, wherein said center server comprises:
means for regarding object data satisfying a predetermined condition out of object data of each player generated by a game executed by said game device as a competing object, receiving the object data of said competing object and said player ID corresponding to said data from the arcade system of said each arcade, and storing them in a database in connection with a arcade ID specifying a transmission source arcade and an area ID specifying an area to which the arcade belongs;
means for executing a competing game by each object data corresponding to said arcade ID extracted from said database as a first game for each said arcade ID in order to determine a representative object of said each arcade, for executing a competing game using the representative object data of said each arcade as a second game for each said area ID in order to determine the representative object data of each area, and for executing a nationwide championship game using the representative object data of said each area as a third game in order to determine the representative object data of said area which ranked first in said third game to be champion object data; and
means for regarding the arcade ID and the area ID corresponding to the object data which won said third game and the object ID and the player ID of the object data as distribution data and distributing it to the arcade server of said each arcade, wherein said arcade server comprises means for comparing the area ID within said distribution data received from said center server with the area ID to which a player's own arcade belongs, and when they match each other, for transmitting a first notification message including the player ID within said distribution data to said game device, wherein said game device which has received said first notification message comprises means for writing first bonus data into said external storage medium.

2. The network game system according to claim 1, wherein said arcade server compares the arcade ID within said distribution data received from said center server with a player's own arcade ID, and when they match each other, transmits a second notification message indicating the fact to said game device, wherein said game device which has received said second notification message executes specific image processing in accordance with said second notification message.

3. The network game system according to claim 1, wherein said arcade server comprises means for comparing the arcade ID within said distribution data received from said center server with a player's own arcade ID, and when they match each other, for transmitting the player ID within said distribution data to said game device, wherein said game device compares the player ID within said distribution data received from said arcade server with the player ID read from a storage section of the external storage medium possessed by said player, and when they match each other, judges that the player specified by said player ID is the player corresponding to said champion object data, and writes second bonus data into said external storage medium.

4. The network game system according to claim 1, wherein said game device comprises a plurality of satellite devices and a main monitor, and when it receives said first notification message or said second notification message, allows a display section of said satellite device or said main monitor to display a specific image in accordance with either one of said notification messages.

5. The network game system according to claim 1, wherein said arcade system further comprises a terminal device which is connected to said center server in a communicable manner, wherein said center server further comprises means for receiving the expectation voting data of voting participants who predicted the result of said competing game from said terminal device before the execution of said competing game, and executing a expectation game on the basis of said expectation voting data of each voting participant.

6. A competing game processing method in a network game system comprising:
a arcade system in which a game device provided with a card processing section which reads at least a player ID from an external storage medium possessed by a player or writes data into said storage medium and a arcade server are connected to each other in a mutually communicable manner; and
a center server which is connected to said arcade system installed in each of a plurality of arcades through a communications network in a communicable manner, wherein said center server comprises:
a step for regarding object data satisfying a predetermined condition out of object data of each player generated by a game executed by said game device as a competing object, receiving the object data of said competing object and said player ID corresponding to said data from the arcade system of said each arcade, and storing them in a database in connection with a arcade ID specifying a transmission source arcade and an area ID specifying an area to which the arcade belongs;
a step for executing a competing game using each object data corresponding to said arcade ID extracted from said database as a first game for each said arcade ID in order to determine a representative object of said each arcade, for executing a competing game using the representative object data of said each arcade as a second game for each said area ID in order to determine the representative object data of each area, and for executing a nationwide championship game using the representative object data of said each area as a third game in order to determine the representative object data of said area which ranked first in said third game to be said champion object data; and
a step for regarding the arcade ID and the area ID corresponding to the object data which won said third game and the object ID and the player ID of the object data as distribution data and distributing it to the arcade server of each said arcade, wherein said arcade server comprises means for comparing the area ID within said distribution data received from said center server with the area ID to which a player's own arcade belongs, and when they match each other, for transmitting a first notification message including the player ID within said distribution data to said game device, wherein said game device which has received said first notification message comprises means for writing first bonus data into said external storage medium.

7. A program product for allowing a network game system comprising: a arcade system in which a game device provided with a card processing section which reads at least a player ID from an external storage medium possessed by a player or writes data into said storage medium and a arcade server are connected to each other in a mutually communicable manner and a center server which is connected to said arcade system installed in each of a plurality of arcades through a communications network in a communicable manner to execute a competing game, wherein said center server is allowed to execute:
a step for regarding object data satisfying a predetermined condition out of object data of each player generated by a game executed by said game device as a competing object, receiving the object data of said competing object and said player ID corresponding to said data from the arcade system of said each arcade, and storing them in a database in connection with a arcade ID specifying a transmission source arcade and an area ID specifying an area to which the arcade belongs;
a step for executing a competing game using each object data corresponding to said arcade ID extracted from said database as a first game for each said arcade ID in order to determine a representative object of said each arcade, for executing a competing game using the representative object data of said each arcade as a second game for each said area ID in order to determine the representative object data of each area, and for executing a nationwide championship game using the representative object data of said each area as a third game in order to determine the representative object data of said area which ranked first in said third game to be said champion object data; and
a step for regarding the arcade ID and the area ID corresponding to the object data which won said third game and the object ID and the player ID of the object data as distribution data and distributing it to the arcade server of said each arcade, wherein said arcade server is allowed to execute a step for comparing the area ID within said distribution data received from said center server with the area ID to which a player's own arcade belongs, and when they match each other, for transmitting a first notification message including the player ID within said distribution data to said game device, wherein said game device which has received said first notification message is allowed to execute a step for writing first bonus data into said external storage medium.

8. A storage medium storing the program product executed by the game system described in claim 7.
